(19) United States
(12) Patent Application Publication
(10) Pub. No.: US 2024/0133829 A1
(43) Pub. Date: Apr. 25, 2024

(54) PROCESSING APPARATUS, SYSTEM, METHOD, AND PROGRAM FOR APPLYING NON-NEGATIVE MATRIX FACTORIZATION TO A MEASURED PROFILE OF X-RAY POWDER DIFFRACTION

(71) Applicant: Rigaku Corporation, Tokyo (JP)

(72) Inventors: Takumi OTA, Tokyo (JP); Norihiro MUROYAMA, Tokyo (JP); Akihiro HIMEDA, Tokyo (JP)

(73) Assignee: Rigaku Corporation, Tokyo (JP)

(21) Appl. No.: 18/379,198

(22) Filed: Oct. 12, 2023

(30) Foreign Application Priority Data
Oct. 13, 2022 (JP) 2022-164924

(51) Int. Cl. G01N 23/2055; G01N 23/207; G06F 17/16

(52) U.S. Cl. CPC G01N 23/2055; G01N 23/207; G06F 17/16

(57) ABSTRACT

A processing apparatus, a system, a method and a program for applying non-negative matrix factorization to one or more measured profiles of X-ray powder diffraction based on known information are provided. A processing apparatus for applying non-negative matrix factorization to a measured profile of X-ray powder diffraction comprises a measured profile acquiring section for acquiring one or more measured profiles, a known information acquiring section for acquiring known information including a shape of a predetermined profile corresponding to a background or a predetermined substance included in the measured profile, or a restriction of a coefficient matrix of the predetermined profile, and a decomposition section for applying non-negative matrix factorization to the measured profile based on the known information.

### CROSS-REFERENCE TO RELATED APPLICATION

This application claims priority from Japanese Patent Application No. 2022-164924, filed on Oct. 13, 2022, the entire contents of Japanese Patent Application No. 2022-164924 are incorporated by reference in this application.

### BACKGROUND

### Field

The present disclosure relates to a processing apparatus, a system, a method, and a program.

### Description of the Related Art

X-ray powder diffraction is used in various fields. By analyzing the measured profile of the X-ray powder diffraction, for example, it is possible to identify (qualitative analysis) and quantify the constituents of the powder sample. Conventionally, crystalline phases have been identified by comparing measured profiles or d-I list generated from measured profiles with diffractive patterns of known materials.

Patent Document 1 discloses a crystalline phase identification method for identifying crystalline phases contained in a sample by powder diffraction pattern of the sample with use of database including {a whole pattern fitting step of subjecting a first diffraction pattern which is the powder diffraction pattern to whole pattern fitting with the use of crystalline phase information contained in the sample to calculate a theoretical diffraction pattern of the crystalline phases already identified}, {a residual information generating step of generating residual information on the sample on the basis of a difference between the theoretical diffraction pattern and the first diffraction pattern}, and {a residual information search and matching step of comparing the residual information with the database to select a new crystalline phase contained in the sample}.

Patent Document 2 discloses a spectrum data analysis apparatus for obtaining a plurality of basis spectrum data and activation data representing a magnitude of each basis spectrum by applying non-negative matrix factorization to a set of observation spectrum data obtained for a signal to be analyzed, wherein a minimum value of a value of an objective function including a degree of deviation between a set of observation spectrum data and a set of estimated spectrum data calculated from the plurality of basis spectrum data and the activation data, and a regularization term for evaluating a primary independence of the plurality of basis spectrum data or the activation data is searched for, thereby obtaining the plurality of basis spectrum data and the activation data.

### PATENT DOCUMENT

Patent Document 1: JP-A-2014-178203

Patent Document 2: JP-A-2019-87042

The measured profile of X-ray powder diffraction results in more overlap of the peaks of each profile when there is a lot of mixture. However, in such cases, if the methods described in Patent Document 1 in which search/match is performed using a d-I list as in the related art without processing the measured profile are applied, the accuracy of the qualitative analyses deteriorates.

Further, the technique disclosed in Patent Document 2 increases the accuracy of decomposition by taking into account the assumption that the independence between profiles is high. However, if the overlap of the peaks of each profile is large, imposing a regularization on the primary independence increases the likelihood that each profile cannot be correctly decomposed, and the accuracy of the subsequent qualitative analysis deteriorates.

### SUMMARY

As a result of intensive research, the present inventors have found that the measured profile of X-ray powder diffraction often has accompanying known information, and by applying non-negative matrix factorization to the measured profile based on the known information, the accuracy of decomposition and the accuracy of subsequent qualitative analysis become higher than those in non-negative matrix factorization without using the known information, and thus the present disclosure has been completed.

The present disclosure has been made in view of such circumstances and provides a processing apparatus, a system, a method, and a program for applying non-negative matrix factorization to a measured profile of X-ray powder diffraction based on known information.

(1) A processing apparatus of the present disclosure is a processing apparatus for applying non-negative matrix factorization to one or more measured profiles of X-ray powder diffraction, comprising a measured profile acquiring section for acquiring one or more measured profiles, a known information acquiring section for acquiring known information including a shape of a predetermined profile corresponding to a background or a predetermined substance included in the measured profile, or a restriction of a coefficient matrix of the predetermined profile, and a decomposition section for applying non-negative matrix factorization to the measured profile based on the known information.

(2) Further, in the processing apparatus of the present disclosure, the decomposition section, according to the presence or absence of the known information, selectively performs a normal non-negative matrix factorization or a non-negative matrix factorization with a constraint based on the known information.

(3) Further, in the processing apparatus of the present disclosure, the known information is information indicating that the coefficient matrix of the predetermined profile commonly included in the plurality of measured profiles has the same values.

(4) Further, in the processing apparatus of the present disclosure, the known information is information of a shape of the predetermined profile included in the measured profile.

(5) Further, in the processing apparatus of the present disclosure, the information on the shape of the predetermined profile is information obtained from a database or information based on measured data.

(6) Further, the processing apparatus of the present disclosure further comprises a dendrogram generating section for calculating a statistic between the plurality of measured profiles and generating a dendrogram, and wherein the decomposition section applies non-negative matrix factorization to a cluster including a group of similar profiles selected by the processing apparatus or selected by a user from the dendrogram.

(7) Further, the processing apparatus further comprises a peak search section for performing a peak search on the profile obtained by the non-negative matrix factorization and generating a d-I list; and an identification section for performing a qualitative analysis using the d-I list.

(8) Further, the processing apparatus of the present disclosure further comprises a quantification section for performing quantitative analysis using the qualitatively analyzed data.

(9) Further, the system of the present disclosure, comprises an X-ray diffractometer comprising an X-ray generating section for generating X-rays, a detector for detecting X-rays and a goniometer for controlling rotation of a sample and the processing apparatus described in any of (1) to (8).

(10) Further, the method of the present disclosure is a method for applying non-negative matrix factorization to one or more measured profiles of X-ray powder diffraction, comprising the steps of, acquiring one or more measured profiles, acquiring known information including a shape of a predetermined profile corresponding to a background or a predetermined substance included in the measured profile, or a restriction of a coefficient matrix of the predetermined profile, and applying non-negative matrix factorization to the measured profile based on the known information.

(11) Further, the program of the present disclosure is a program for applying non-negative matrix factorization to one or more measured profiles of X-ray powder diffraction, causing a computer to execute the processes of, acquiring one or more measured profiles, acquiring known information including a shape of a predetermined profile corresponding to a background or a predetermined substance included in the measured profile, or a restriction of a coefficient matrix of the predetermined profile, and applying non-negative matrix factorization to the measured profile based on the known information.

### BRIEF DESCRIPTION OF THE DRAWINGS

FIGS. 1A and 1B are conceptual diagrams showing the manner of non-negative matrix factorization and the manner of non-negative matrix factorization when known information is included, respectively.

FIG. 2 is a schematic diagram showing an example of a configuration of the X-ray diffraction measuring system.

FIG. 3 is a block diagram showing an example of a configuration of the control apparatus.

FIG. 4 is a block diagram showing a modified example of a configuration of the control apparatus and the processing apparatus.

FIG. 5 is a block diagram showing a modified example of a configuration of the control apparatus and the processing apparatus.

FIG. 6 is a block diagram showing a modified example of a configuration of the processing apparatus.

FIG. 7 is a block diagram showing a modified example of a configuration of the processing apparatus.

FIG. 8A is a schematic diagram showing an example of UI for calling a function of cluster analysis.

FIG. 8B is a schematic diagram showing an example of UI for setting or the like of a function of cluster analysis.

FIG. 9 is a schematic diagram describing a function of a part of UI of cluster analysis.

FIG. 10 is a schematic diagram showing an example of a dialog for setting known information.

FIG. 11 is a schematic diagram showing an example of UI for setting or the like of generating a dendrogram.

FIG. 12 is a schematic diagram showing an example of UI for setting or the like of a search/match function and a quantitative analysis function.

FIG. 13 is a flowchart showing an example of the operation of the processing apparatus.

FIG. 14 is a flowchart showing a modified example of the operation of the processing apparatus.

FIG. 15 is a flowchart showing a modified example of the operation of the processing apparatus.

### DETAILED DESCRIPTION

Next, exemplary embodiments of the present disclosure are described with reference to the drawings. To facilitate understanding of the description, the same reference numerals are assigned to the same components in the respective drawings, and duplicate descriptions are omitted.

### [Principle]

A measured profile of X-ray powder diffraction includes profiles of a plurality of substance and a background. If there are many mixtures, there are many peak overlaps. In such cases, the accuracy of the peak search is lowered, and conventional search/match performed using the d-I list is often not suitable.

Non-negative matrix factorization (NMF: Non-negative Matrix Factorization) indicates decomposing a non-negative matrix into the product of non-negative matrices. To facilitate the search/match, it is considered to decompose the measured profile of the X-ray powder diffraction into a weighted sum of multiple profiles (including background profiles). Since each profile and its weights are both non-negative values, non-negative matrix factorization is suitable for representing the measured profile of X-ray powder diffraction as a weighted sum of a plurality of profiles.

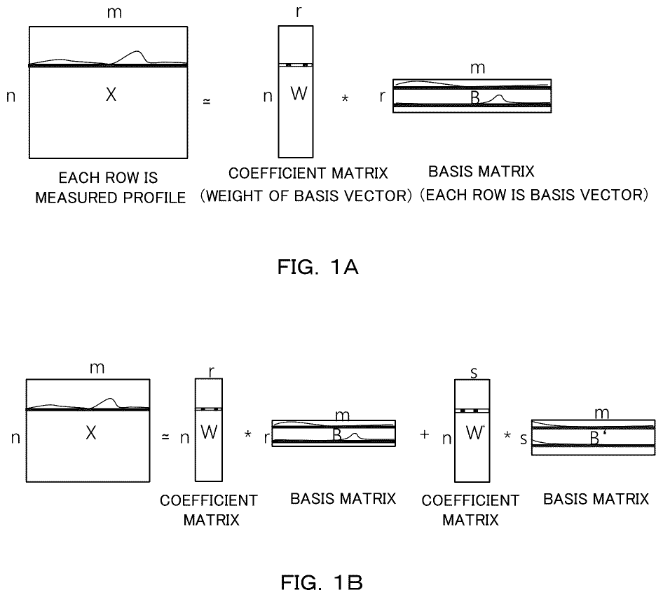

FIG. 1A is a conceptual diagram showing the manner of non-negative matrix factorization. The left side of FIG. 1A shows a matrix of n measured profiles of X-ray powder diffraction with m measurement points. The result obtained by applying non-negative matrix factorization to the left side is the right side of the FIG. 1A. However, the equal symbol with waved line in FIG. 1 includes not only an exact match but also a case where the degree of deviation indicating the degree of the neighborhood between the left side and the right side is a predetermined value or less.

The measured profile of X-ray powder diffraction may have a large overlap of profiles. The case where the overlap of the profiles is large refers to, for example, a case where overlaps of peaks of respective profiles are many, a case where amorphous is included in the sample, a case where the background is large, or the like. In such a case, it is not appropriate to perform the non-negative matrix factorization by imposing the regularization on the primary independence as in Patent Document 2, since the accuracy of the subsequent search/match may be lowered.

In addition, for the measured profile of X-ray powder diffraction, accompanied known information is often recognized. The method of the present disclosure applies non-negative matrix factorization to the measured profile of X-ray powder diffraction based on known information. The non-negative matrix factorization of the measured profile based on the known information indicates that non-negative matrix factorization is applied to the measured profile so that the constraint is satisfied when the known information is used as the constraint. The method of the present disclosure enables accurate non-negative matrix factorization even when the overlap of profiles is large. It should be noted that although various methods have been proposed for applying non-negative matrix factorization to a given non-negative matrix, the present disclosure can use a general method.

In FIG. 1A, it is assumed that the known information associated with the measured profile of X-ray powder diffraction is known. The known information is information associated with the measured profile of X-ray powder diffraction. Details are described below. In such a case, a decomposition in which the known information appropriately appears as a result of the non-negative matrix factorization is a more accurate decomposition. If the right side of the FIG. 1A contains known information, the known information can be retrieved and represented, for example, as in the second term on the right side of the FIG. 1B. FIG. 1B is a conceptual diagram showing the manner of the non-negative matrix factorization when known information is included.

According to the method of the present disclosure, the known information is set to one or more of the matrix W with N rows and R columns on the right side of the FIG. 1B, the matrix W′ with N rows and S columns, or the matrix B′ with S rows and M columns, depending on the type or the like of the known information. The matrix W′, W and B with R rows and M columns is optimized under the constraint. The optimization is to obtain a basis matrix and a coefficient matrix of which the degree of deviation is a predetermined value or less. Thus, the decomposition can be performed such that the known information appropriately appears as a result of the non-negative matrix factorization.

As described above, the method of the present disclosure enables applying non-negative matrix factorization to the measured profile of X-ray powder diffraction based on known information. The detailed method according to the present disclosure is detailed in the embodiment.

### EMBODIMENT

The method according to the present disclosure is explained in detail, as described below. Hereinafter, a method of applying non-negative matrix factorization to a measured profile of X-ray powder diffraction measured by an X-ray diffractometer is described. Further, a method of performing qualitative analysis and a method of performing quantitative analysis using the same are described.

A matrix with N rows and M columns in which N measured profiles of X-ray powder diffraction having M measurement points are arranged is denoted by X. The non-negative matrix factorization of X is expressed by the following formula (1). W is a coefficient matrix, and B is a basis matrix. W represents the weight of B. In B, each row is a basis vector. Further, R is a hyper parameter indicating the number of basis vectors.

$$X ( n , m ) ≅ {\sum }_{r} W ( n , r ) * B ( r , m ) \qquad ( 1 )$$

It is assumed that a portion of W or B on the right side of formula (1) contains known information associated with the measured profile of X-ray powder diffraction. When a coefficient matrix or a basis matrix indicating known information is extracted from W or B in formula (1) and is represented as W′ or B′, the non-negative matrix factorization of X can be rewritten as in formula (2) below. However, any one or more of W, W′ or B′ shall contain known information. S is a hyper parameter indicating the number of basis vectors of known information. In addition, the formulae after extracting W′ and B′ are set to W and B again.

$$X ( n , m ) ≅ {\sum }_{r} W ( n , r ) * B ( r , m ) + {\sum }_{s} {W}^{′} ( n , s ) * {B}^{′} ( r , s ) \qquad ( 2 )$$

The known information of the measured profile of the X-ray powder diffraction is information including a shape of a predetermined profile corresponding to a background included in the measured profile, a shape of a predetermined profile corresponding to a predetermined substance included in the measured profile, or a restriction of a coefficient matrix of a predetermined profile. Such known information is set to any one or more of W, W′ or B′ and W′, W and B are optimized under the constraint. Thus, the non-negative matrix factorization can be performed with a constraint of the known information for the measured profile of the X-ray powder diffraction. It should be noted that formula (2) is a format for easily indicating that there is known information, and the optimization may be performed by setting known information in formula (1).

In one aspect, the known information is information indicating that the values of the coefficient matrix of the predetermined profile commonly included in the plurality of measured profiles are equal. This results in a non-negative matrix factorization with the constraint that multiple measured profiles commonly contain equal amounts of components. For example, that can be applied to a case where a background due to an apparatus is common to a plurality of measured profiles, a case where an equal amount of a standard substance is contained in the samples, and the like. It can also be applied, for example, in a case where there is a profile according to a component that does not react during the measurement when a plurality of measured profiles is measured over time for a single sample.

For example, a plurality of measured profiles measured in one X-ray diffractometer under the same condition include the same background. Thus, if it is known that there is a profile shape common to a plurality of measured profiles, but its shape is not known, the W and the basis matrix B are optimized by imposing a restriction that the values of a certain column of the coefficient matrix W are equal.

In one aspect, the known information is information of a shape of a predetermined profile included in the measured profile. This results in a non-negative matrix factorization with the constraint that one or more measured profiles contain a known profile. For example, that can be applied to a case where the background shape is known, a case where the inclusions in the sample are known, and the like. The information on the shape of the predetermined profile may be information obtained from a database or information based on measured data.

For example, if the background shape of the measured profile is known, a profile indicating the background shape is set to the base matrix B′, and the coefficient matrices W′, W, and B are optimized.

In one aspect, the non-negative matrix factorization is performed by a normal non-negative matrix factorization or a non-negative matrix factorization with a constraint based on the known information, depending on the presence or absence of the known information. Accordingly, in the presence of known information, non-negative matrix factorization can be accurately applied to the measured profile according to the type and content of the known information. Further, in the absence of known information, non-negative matrix factorization can be applied to the measured profile without constraints.

For the non-negative matrix factorization, a method such as an alternating least squares method, a multiplicative update method, a coordinate descent method, and the like plus regularization can be applied. As regularization, the weights and the sparsity of the decomposed profiles can be imposed.

If there are multiple measured profiles, statistics between the measured profiles and generate a dendrogram can be calculated. In addition, a processing apparatus to be described later may apply non-negative matrix factorization to a cluster including a similar profile group selected from a dendrogram or selected by a user.

When non-negative matrix factorization can be accurately applied to a plurality of measured profiles, characteristic profiles may be included in most measured profiles. By generating a dendrogram and selecting a cluster containing similar profile groups from the generated dendrogram, it can be expected that measured profiles that are less likely to contain characteristic profiles will be eliminated. As a result, non-negative matrix factorization can be accurately applied to a plurality of measured profiles.

In one aspect, the qualitative analysis is performed after non-negative matrix factorization is applied to the measured profile. In the qualitative analyses, peak searching may be performed on the profile (basis vector) obtained by non-negative matrix factorization and that a d-I list is generated. A qualitative analysis can be performed by performing a search/match using the generated d-I list. Qualitative analysis can be performed using known methods. Since the profile after non-negative matrix factorization has fewer peaks than the measured profile before non-negative matrix factorization, qualitative analyses using d-I listing generated from the decomposed profile often facilitate the identification of components or increase the accuracy of identification.

In one aspect, if a qualitative analysis is performed after non-negative matrix factorization is applied to the measured profile, further quantitative analysis is performed as necessary. Quantitative analysis is performed using qualitatively analyzed data. Quantitative analysis can be performed using known methods.

In this way, the measured profile of the X-ray powder diffraction measured by the X-ray diffractometer can be decomposed through non-negative matrix factorization based on the known information. It can also be used for qualitative and quantitative analyses.

### [Whole System]

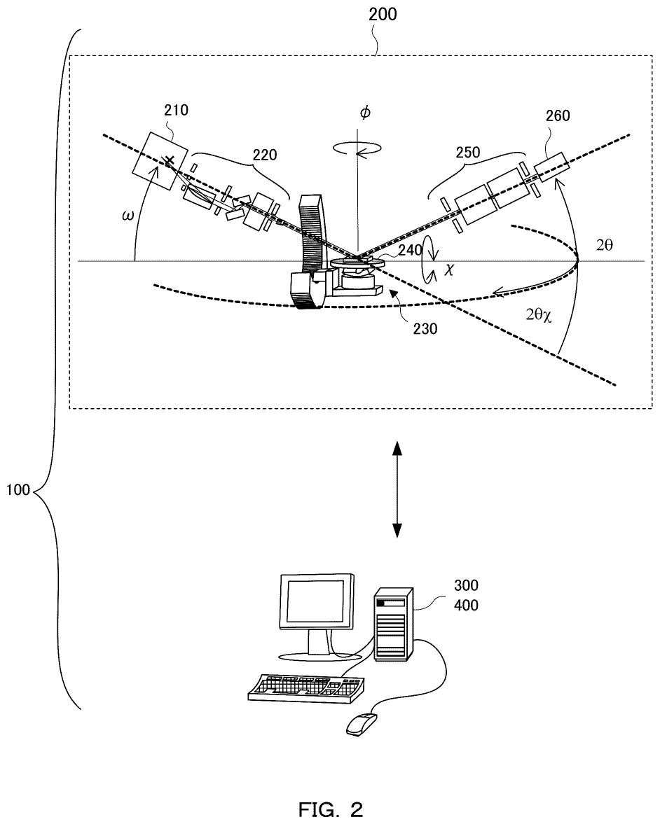

FIG. 2 is a schematic diagram showing an example of a configuration of an X-ray diffraction measurement system 100. The system 100 includes an X-ray diffractometer 200, a control apparatus 300, and a processing apparatus 400. The X-ray diffractometer 200 constitutes an optical system for making X-rays incident on a sample and detecting diffracted X-rays generated from the sample, and the optical system comprises a goniometer. Incidentally, the configuration shown in FIG. 2 is one example, and thus a variety of other configurations may be adopted.

The control apparatus 300 is connected to the X-ray diffractometer 200 and controls the X-ray diffractometer 200 and processes and stores the acquired data. The processing apparatus 400 applies non-negative matrix factorization to the measured profile of the X-ray powder diffraction. The control apparatus 300 and the processing apparatus 400 are apparatuses including CPU and memories and may be PC terminals or servers on the cloud. Not only the whole apparatus but also part of the apparatus or some functions of the apparatus may be provided on the cloud. The input device 510 is, for example, a keyboard or a mouse, and performs input to the control apparatus 300 or the processing apparatus 400. The display device 520 is, for example, a display, and displays a measured profile, a result of non-negative matrix factorization, and the like.

Using such a system 100, the profile of the X-ray powder diffraction can be measured, and the measured profile can be decomposed through non-negative matrix factorization. In addition, qualitative analysis and quantitative analysis can be performed using a profile obtained by non-negative matrix factorization.

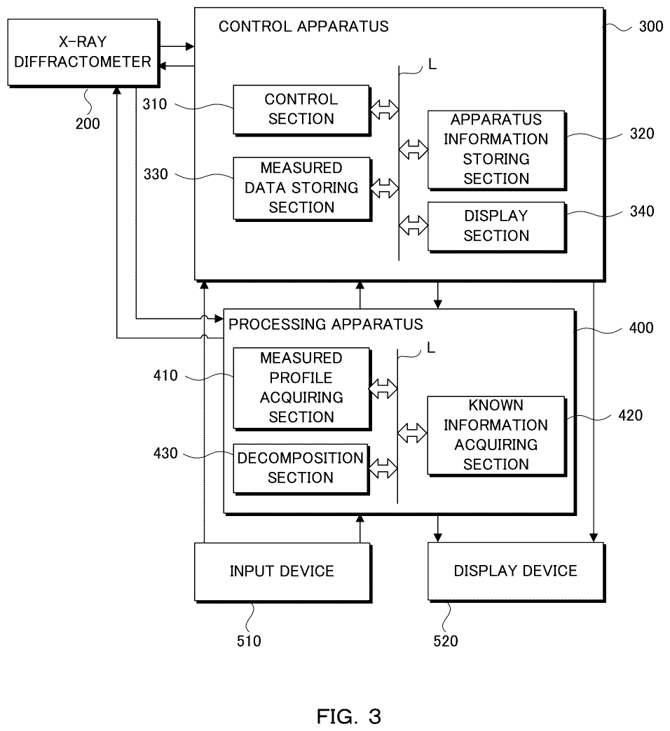

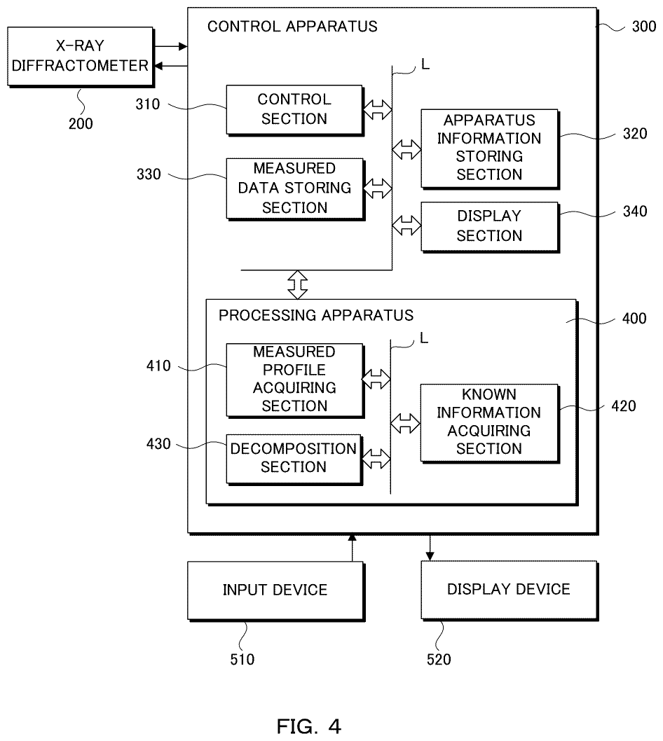

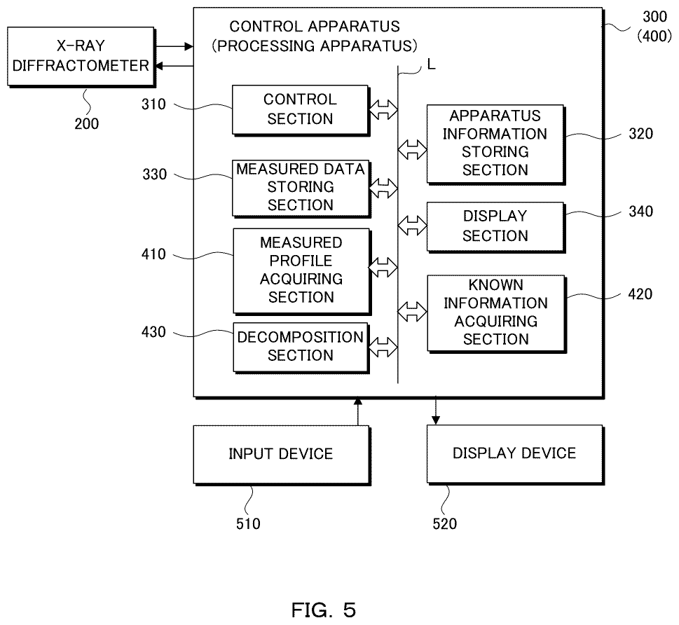

In FIG. 2, the control apparatus 300 and the processing apparatus 400 are described as the same PC. However, as described above, the method of the present disclosure can obtain a measured profile and perform non-negative matrix factorization independently of the X-ray diffractometer 200 and the control apparatus 300. Therefore, as shown in FIG. 3, the processing apparatus 400 may be configured as an apparatus different from the control apparatus 300. FIG. 3 is a block diagram illustrating an example of a configuration of the control apparatus 300 and the processing apparatus 400. Further, as shown in FIG. 4, the processing apparatus 400 may be configured as a part of functions included in the control apparatus 300. As shown in FIG. 5, the processing apparatus 400 and the control apparatus 300 may be configured as an integrated apparatus. FIG. 4 and FIG. 5 are block diagrams showing modified examples of the configurations of the control apparatus 300 and the processing apparatus 400. Hereinafter, a case where the control apparatus 300 and the processing apparatus 400 are configured as different apparatuses is described.

### [X-ray Diffractometer]

The X-ray diffractometer 200 comprises an X-ray generation section 210 that generates X-rays from an X-ray focus, that is, an X-ray source; an incident side optical unit 220; a goniometer 230; a sample table 240 where a sample is set; an emitting side optical unit 250; and a detector 260 that detects X-rays. The X-ray generation section 210, the incident side optical unit 220, the goniometer 230, the sample table 240, the emitting side optical unit 250, and the detector 260 each constituting the X-ray diffractometer 200 may be those generally available, and thus descriptions are omitted.

### [Control Apparatus]

The control apparatus 300 is constituted from a computer formed by connecting CPU (Central Processing Unit/Central Processor), ROM (Read Only Memory), RAM (Random Access Memory) and a memory to a bus. The control apparatus 300 is connected to the X-ray diffractometer 200 to receive information.

The control apparatus 300 comprises the control section 310, the apparatus information storing section 320, the measured data storing section 330, and the display section 340. Each section can transmit and receive information via the control bus L. The input device 510 and the display device 520 are connected to CPU via an appropriate interface.

The control section 310 controls the operations of the X-ray diffractometer 200. The apparatus information storing section 320 stores apparatus information acquired from the X-ray diffractometer 200. The apparatus information includes information about the X-ray diffractometer 200 such as name of the apparatus, the kind of a radiation source, a wavelength, a background, and so forth. In addition, information necessary for applying non-negative matrix factorization to the measured profile of the X-ray powder diffraction, such as the type and composition of constituent elements of the sample, may be included.

The measured data storing section 330 stores the measured profile acquired from the X-ray diffractometer 200. The measured profile may include information necessary to apply non-negative matrix factorization to the measured profile of the X-ray powder diffraction, such as source type, wavelength, background, type of constituent element of the sample, composition, and the like. The display section 340 causes the display device 520 to display the measured profile. Thus, the measured profile can be confirmed by the user. In addition, the user can provide instruction and designation to the control apparatus 300, the processing apparatus 400, and the like based on the measured data.

### [Processing Apparatus]

The processing apparatus 400 is configured from a computer formed by connecting CPU, ROM, RAM and a memory to a bus. The processing apparatus 400 may be connected to the X-ray diffractometer 200 via the control apparatus 300.

The processing apparatus 400 comprises a measured profile acquiring section 410, a known information acquiring section 420, and a decomposition section 430. Each section can transmit and receive information via the control bus L. When the processing apparatus 400 is a separate configuration from the control apparatus 300, the input device 510 and the display device 520 are also connected to CPU of the processing apparatus 400 via an appropriate interface. In this case, the input device 510 and the display device 520 each may differ from one connected to the control apparatus 300.

The measured profile acquiring section 410 acquires one or more measured profiles. The measured profile acquiring section 410 may acquire the measured profile from the X-ray diffractometer 200 directly or via the control apparatus 300.

The known information acquiring section 420 acquires known information including a shape of a predetermined profile corresponding to a background included in the measured profile, a shape of a predetermined profile corresponding to a predetermined substance included in the measured profile, or a restriction of a coefficient matrix of the predetermined profile.

In one aspect, the known information acquired by the known information acquiring section 420 is information indicating that a coefficient matrix of a predetermined profile commonly included in a plurality of measured profiles has the same values. Thus, for example, when the background due to the X-ray diffractometer 200 is common, or when an equal amount of a standard substance is included in the samples, it is possible to perform non-negative matrix factorization using such known information.

In one aspect, the known information acquired by the known information acquiring section 420 is information of a shape of a predetermined profile included in the measured profile. Thus, for example, when the background shape is known or the inclusions are known, non-negative matrix factorization using such known information can be performed. Further, the information on the shape of the predetermined profile may be information obtained from a database or information based on measured data.

The decomposition section 430 decomposes the measured profile through non-negative matrix factorization based on the known information. The non-negative matrix factorization of the measured profile based on the known information indicates that the measured profile is decomposed through non-negative matrix factorization so that the constraint is satisfied when the known information is used as a constraint.

In one aspect, the decomposition section 430 performs a normal non-negative matrix factorization or a non-negative matrix factorization with a constraint based on the known information selectively according to the presence or absence of the known information.

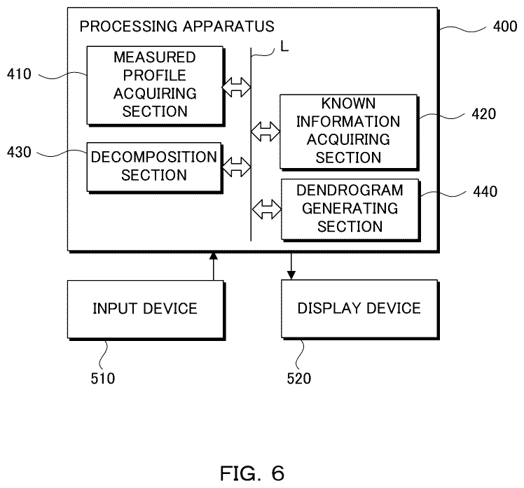

FIG. 6 is a block diagram showing a modified example of the configuration of the processing apparatus 400. In one aspect, as shown in FIG. 6, the processing apparatus 400 comprises a dendrogram generating section 440. The dendrogram generating section 440 calculates a statistic between the plurality of profiles and generates a dendrogram.

In one aspect, when the dendrogram generating section 440 generates a dendrogram, the decomposition section 430 applies non-negative matrix factorization to a cluster including a similar profile group selected by the processing apparatus 400 or selected by the user from the dendrogram. Thus, the accuracy of the non-negative matrix factorization can be improved.

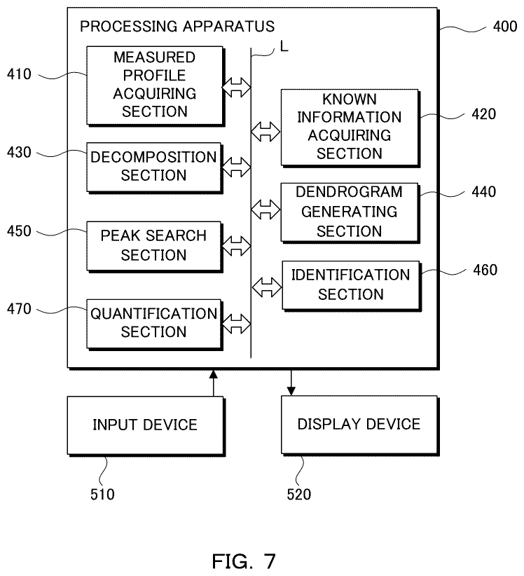

FIG. 7 is a block diagram showing a modified example of the configuration of the processing apparatus 400. In one aspect, as shown in FIG. 7, the processing apparatus 400 comprises a dendrogram generating section 440, a peak search section 450, an identification section 460, and a quantification section 470. The dendrogram generating section 440 is the same as that described above.

The peak search section 450 performs peak search on the profile (basis vector) obtained by non-negative matrix factorization and generates a d-I list. The peak search is performed on the selected one of the profiles obtained by the non-negative matrix factorization. The selection of the profile may be performed by the user or by another functional section of the peak search section 450 or the processing apparatus 400. In addition, a d-I list is generated for each profile performed the peak search. The peak search may be performed on all profiles other than those determined to be background.

The identification section 460 performs qualitative analysis using the d-I lists. The qualitative analyses can be performed by performing search/match on the generated d-I lists. The quantification section 470 performs quantitative analysis using the qualitatively analyzed data. In the configuration of FIG. 7, the dendrogram generating section 440, the peak search section 450, the identification section 460, and the quantification section 470 are arbitrary functional sections, and any one or more of them may be omitted.

### [User Interface]

In one aspect, when the parameters and the like are instructed to the processing apparatus 400 by the user, a user interface (UI) function that allows various settings to be input by, for example, a mouse operation or a keyboard operation is used. The function of the processing apparatus 400 may be configured to cooperate with the function of another apparatus. Hereinafter, an example of UI for setting parameters to the processing apparatus 400 and an example of UI when the function of the processing apparatus 400 cooperates with the function of another apparatus are described. It is assumed that the functions of the processing apparatus 400 are implemented as software.

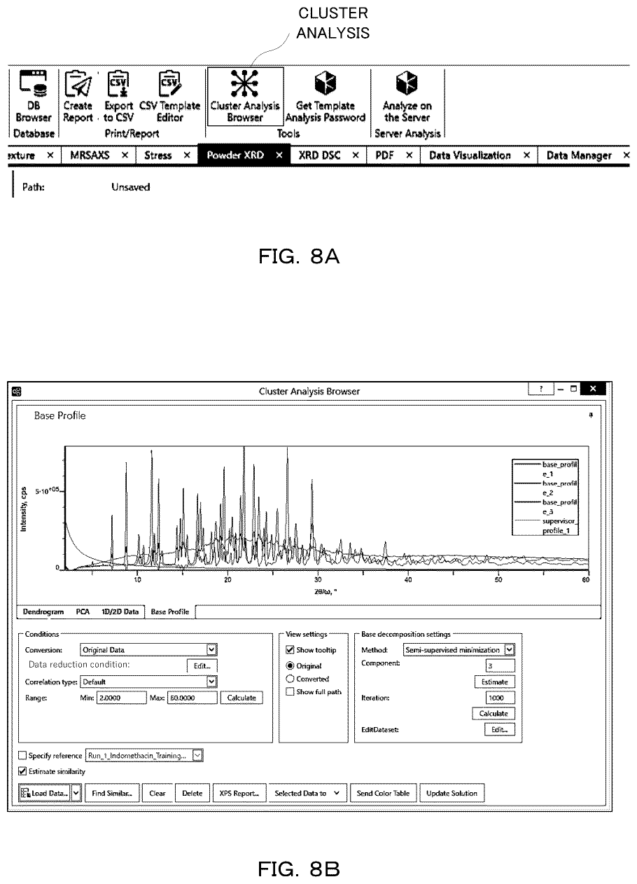

FIG. 8A is a schematic diagram showing an example of UI for calling a function of cluster analysis. FIG. 8B is a schematic diagram showing an example of UI for setting or the like of a function of cluster analysis. It is assumed that the cluster analysis function in FIG. 8B includes the function of the processing apparatus 400. When the button of the cluster analysis is pressed on the screen in FIG. 8A, the screen in FIG. 8B is launched.

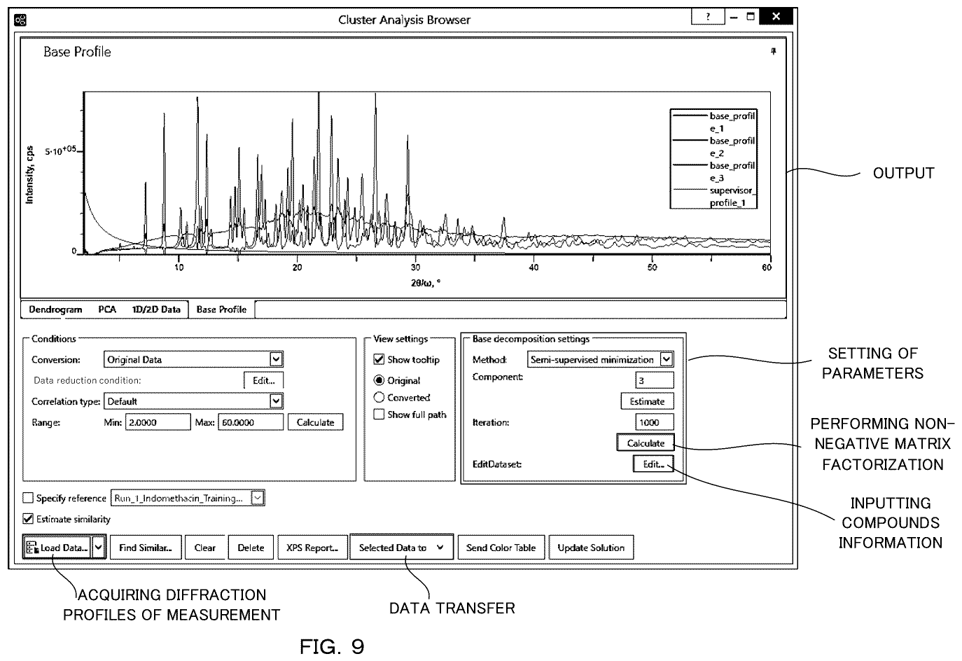

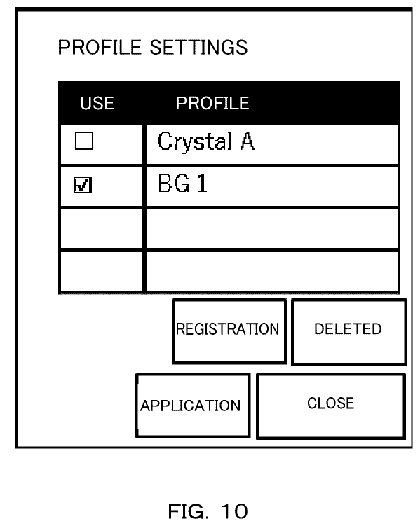

FIG. 9 is a schematic diagram describing a partial function of a UI for cluster analysis (a UI in FIG. 8B). On the screen in FIG. 9, the user may provide instructions to the processing apparatus 400 for obtaining a measured profile, setting parameters, performing non-negative matrix factorization, inputting compound information, outputting a result of non-negative matrix factorization, transferring data, and the like. The optimization method of the non-negative matrix factorization, the value of the hyperparameter, the number of iterations, regularization, and the presence or absence of known information can be set with the parameter setting panel. The value of the hyper parameter may be automatically estimated and set using the Akaike's information criterion, the Bayesian information criterion, or the like, or the estimated value may be displayed by Estimate button. The data resulting from non-negative matrix factorization is transferred to search/match and quantification functions with the Data Transfer button. FIG. 10 is a schematic diagram showing an example of a dialog for setting known information. The contents of the known information can be set on the dialog in FIG. 10.

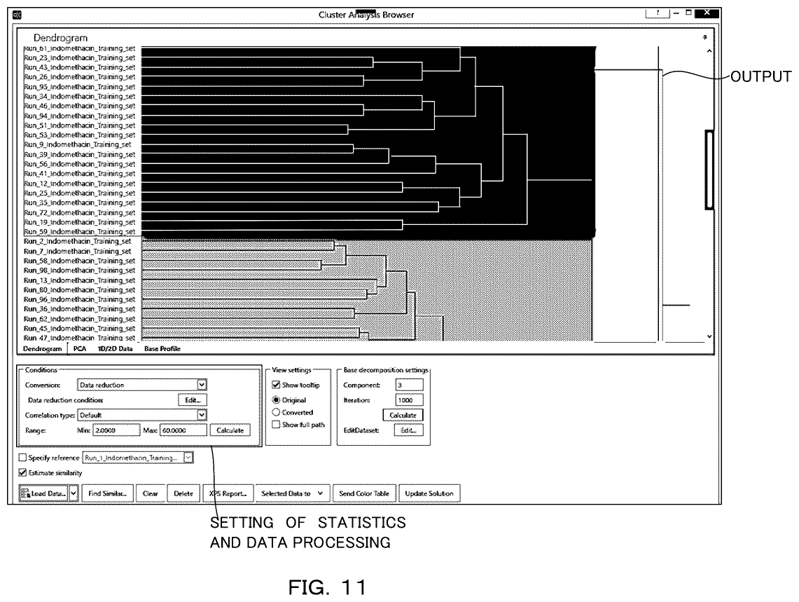

FIG. 11 is a schematic diagram showing an example of UI for setting or the like of generating a dendrogram. On the screen in FIG. 11, the user can give instructions to the processing apparatus 400 such as statistics for dendrogram generation, data processing sets, cluster selection, and the like.

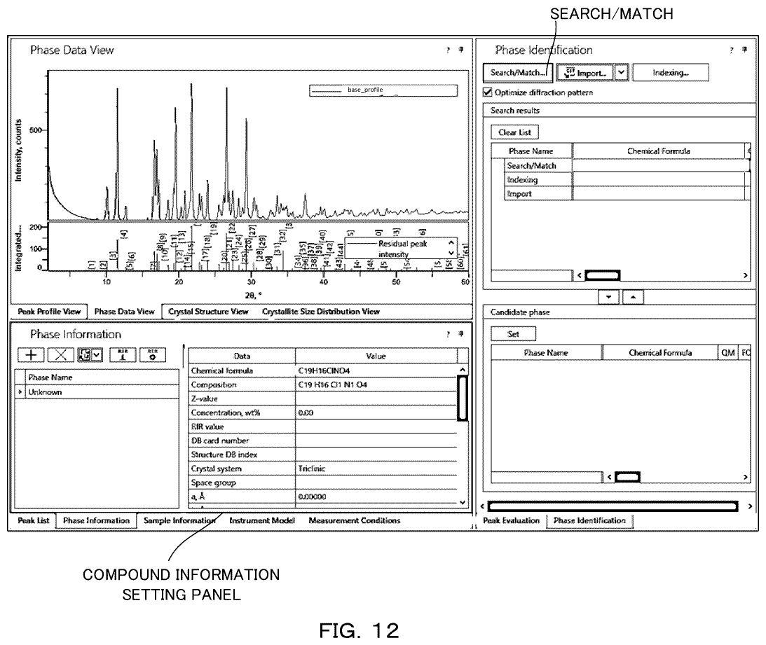

FIG. 12 is a schematic diagram showing an example of UI for setting or the like of a search/match function and a quantitative analysis function. By pressing the Data Transfer button on the screen in FIG. 9, the screen in FIG. 12 is launched. On the screen in FIG. 12, the user can give an instruction to the processing apparatus 400 or other apparatus such as execute of search/match, setting of compound information and the like.

It should be noted that the setting items and the like displayed in FIGS. 8 to 12 are examples, and even when the user sets them, only a part of them may be set, or all of them may be set. In addition, there may be setting items and functions that are not displayed in FIGS. 8 to 12.

### [Measurement Method]

A sample S is installed in the X-ray diffractometer 200, and the goniometer is driven under a predetermined condition based on the control of the control apparatus 300. Further, X-rays are incident on the sample, and diffracted X-rays generated from the sample are detected.

Thus, the diffraction data is acquired. The X-ray diffractometer 200 transmits the apparatus information or the like and the acquired diffraction data as the measured data to the control apparatus 300.

### [Disassembly Method]

### (Description of Flow in Performing Only Non-Negative Matrix Factorization)

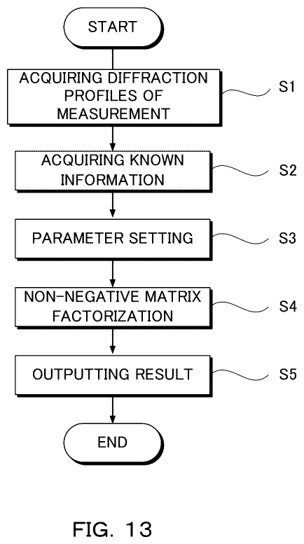

FIG. 13 is a flowchart showing an example of the operation of the processing apparatus 400. FIG. 13 shows an example of the operation in the case where only the non-negative matrix factorization is performed. First, the processing apparatus 400 acquires a measured profile (step S1). Next, known information of the acquired measured profile is obtained (step S2). The known information may be obtained from the X-ray diffractometer 200 or the control apparatus 300 or may be obtained by user input. Since the known information is associated with the measured profile, it may be acquired at the same time as the acquisition of the measured profile. The known information common to a plurality of measured profiles to be used when non-negative matrix factorization is performed may not be determined at the time of obtaining known information, and thus the known information to be used may be determined among the obtained known information.

Next, the parameters are set (step S3). The parameters to be set are parameters necessary for optimization of the number of basis vectors to be decomposed (values of hyper-parameters), the optimization method and the like. The parameters may be set as input by the user or may be determined and set by the processing apparatus 400 based on the measured profile or the known information. Next, non-negative matrix factorization is performed (step S4). Non-negative matrix factorization is performed by generating a matrix consisting of measured profiles, setting known information in a basis matrix or coefficient matrix, and optimizing the basis matrix and coefficient matrix other than the known information. Then, the result is output as needed (step S5), and the process ends. A configuration may be adopted in which only the result is stored and output when an instruction is given from the user. In this way, the measured profile of the X-ray powder diffraction can be decomposed through non-negative matrix factorization based on known information.

In obtaining the known information in the step S2 of the flow chart of FIG. 13, when the known information does not accompany the acquired measured profile or when the known information is not input by the user, subsequent processes may be performed without obtaining the known information. That is, the known information may be checked in acquiring the known information, and a normal non-negative matrix factorization or a non-negative matrix factorization with a constraint based on the known information may be selectively performed according to the presence or absence of the known information. In addition, when it is confirmed that there is known information, it may be determined whether a constraint is added to the basis matrix, a constraint is added to the coefficient matrix, or both, depending on the content of the known information. In this way, a normal non-negative matrix factorization or a non-negative matrix factorization with a constraint based on the known information can be selectively performed for the measured profile of the X-ray powder diffraction depending on the presence or absence of the known information.

### (Description of Flow in Generating Dendrogram)

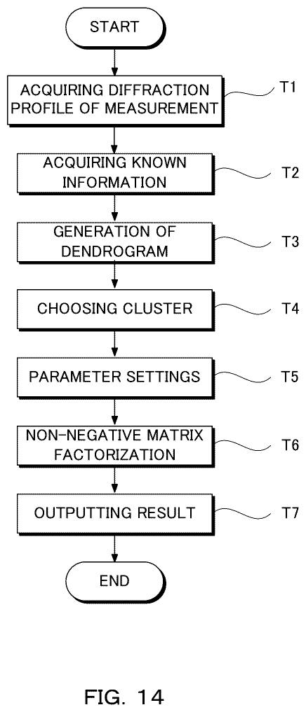

FIG. 14 is a flowchart showing a modified example of the operation of the processing apparatus 400. FIG. 14 shows an example of an operation when a dendrogram is generated. In the following description of the flowchart, the characteristic operation is described in detail, and the description of the operation already described may be omitted. First, the processing apparatus 400 acquires measured profiles (step T1). Next, known information of the acquired measured profile is obtained (step T2).

Next, dendrogram is generated (step S3). The dendrogram is generated by calculating statistics between the acquired plurality of measured profiles. Next, the cluster is selected (step T4). The cluster may be selected by the user or by the processing apparatus. By selecting the cluster being a similar profile group from the dendrograms, the accuracy of the decomposition is improved. The known information common to a plurality of measured profiles (clusters) to be used when non-negative matrix factorization is performed may not be determined at the time of obtaining known information, and thus the known information to be used may be determined among the known information obtained after the cluster selection. In addition, the known information may be obtained after the cluster selection.

Next, the parameters are set (step T5). Next, non-negative matrix factorization is performed (step T6). Then, the result is outputted as needed (T7 of steps), and the process ends. In this way, for data measured with an X-ray diffractometer, the dendrogram is generated, clusters are selected, and non-negative matrix factorization can be performed.

(Description of Flow of Modification in Qualitative analysis or Further Quantitative Analysis)

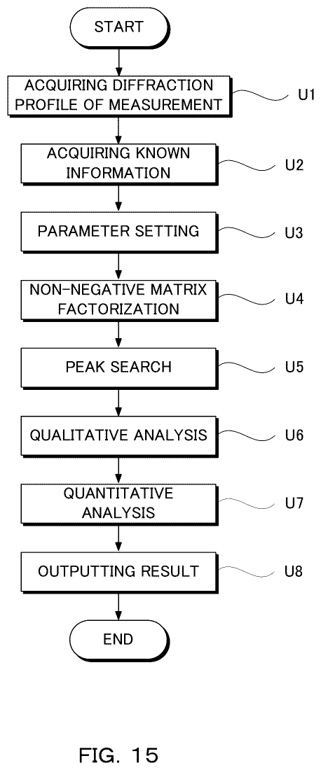

FIG. 15 is a flowchart showing a modified example of the operation of the processing apparatus 400. FIG. 15 shows a variation of the operation in the case of qualitative analysis or further quantitative analysis after the non-negative matrix factorization. From the step of acquiring the measured profile (step U1) to the step of performing the non-negative matrix factorization (step U4) are similar to the step Si to the step S4.

Next, peak search is performed (step U5). Peak search is performed on one of the selected profiles (basis vectors) obtained by the non-negative matrix factorization. The selection of the profile may be performed by the user or by the processing apparatus 400. In addition, a d-I list is generated for each profile performed the peak search. In one aspect, the peak search is performed on all profiles other than those determined to be background.

Next, qualitative analyses are performed (step U6). The qualitative analyses can be performed by performing search/match based on the generated d-I list. If a profile whose matching degree is a predetermined value or greater is not found as a result of the search/match, the process may return to the step U3, and the non-negative matrix factorization may be performed again from the setting of the parameter.

Next, quantitative analysis is performed (step U7). The quantitative analysis determines the content ratio of the substance identified by the qualitative analysis using various methods. For example, DD (Direct Derivation) method, RIR method, the Rietveld method or the like can be used. Then, the result is outputted as needed (step U8), and the process ends. Thus, the measured profile of the X-ray powder diffraction is decomposed through non-negative matrix factorization based on the known information, a qualitative analysis can be performed, and the quantitative analysis can be performed using the same.

In the flow chart in FIG. 15, after the qualitative analysis of the step U6, the result is outputted as needed (step U8) without performing the quantitative analysis, and the process may end. Thus, the measured profile of the X-ray powder diffraction can be decomposed through non-negative matrix factorization based on the known information, and the qualitative analysis can be performed using the non-negative matrix factorization.

Also, in the flow chart in FIG. 15, after acquiring the measured profile in the step U1 or obtaining the known information in the step U2, the flow of generating the dendrogram and selecting the cluster may be added.

The order of the steps in each of the above-described flowcharts is not fixed, and the steps may be changed in order or processed in parallel as long as the steps can be correctly processed. Each flowchart may be applied in combination with other flowcharts.

### EXAMPLE

X-ray diffraction data was measured for a mixture of indomethacin using system 100 configured as described above. To the measured profile, the non-negative matrix factorization is applied with giving the shape of the background profile as the known information. As a result of setting the hyperparameter other than the known information to 3, the profile of indomethacin α type, the profile of indomethacin γ type, the amorphous profile and the background profile could be appropriately decomposed, and the qualitative analysis could be carried out.

Non-negative matrix factorization is applied to the same measured profile using the conventional method. As a result, the indomethacin α-type, indomethacin γ-type, amorphous profile and background profile could not be properly decomposed. This is considered to be because the background and the profile due to the amorphous component greatly overlaps with the profile of the crystal phase. It has been confirmed that the method of the present disclosure can extract the background or the profile due to amorphous components even in such a case.

From the above results, it has been confirmed that the processing apparatus, the system, the method and the program of the present disclosure can apply non-negative matrix factorization to the measured profile of X-ray powder diffraction based on known information.

What is claimed is:

1. A processing apparatus for applying non-negative matrix factorization to one or more measured profiles of X-ray powder diffraction, comprising:
processing circuitry configured to acquire one or more measured profiles, acquire known information including a shape of a predetermined profile corresponding to a background or a predetermined substance included in the measured profile, or a restriction of a coefficient matrix of the predetermined profile, and
apply non-negative matrix factorization to the measured profile based on the known information.

2. The processing apparatus according to claim 1,
wherein the processing circuitry, according to the presence or absence of the known information, is further configured to
selectively perform a normal non-negative matrix factorization or a non-negative matrix factorization with a constraint based on the known information.

3. The processing apparatus according to claim 1,
wherein the known information is information indicating that the coefficient matrix of the predetermined profile commonly included in the plurality of measured profiles has the same values.

4. The processing apparatus according to claim 1,
wherein the information on the shape of the predetermined profile is information obtained from a database or information based on measured data.

5. The processing apparatus according to claim 1, wherein the processing circuitry is further configured to calculate a statistic between the plurality of measured profiles and generate a dendrogram, and
apply non-negative matrix factorization to a cluster including a group of similar profiles selected by the processing apparatus or selected by a user from the dendrogram.

6. The processing apparatus according to claim 1, wherein the processing circuitry is further configured to
perform a peak search on the profile obtained by the non-negative matrix factorization and generate a d-I list, and
perform a qualitative analysis using the d-I list.

7. The processing apparatus according to claim 6, wherein the processing circuitry is further configured to perform quantitative analysis using the qualitatively analyzed data.

8. A system comprising, an X-ray diffractometer comprising an X-ray source for generating X-rays, a detector for detecting X-rays and a goniometer for controlling rotation of a sample, and the processing apparatus according to claim 1.

9. A method for applying non-negative matrix factorization to one or more measured profiles of X-ray powder diffraction, comprising:
acquiring one or more measured profiles;
acquiring known information including a shape of a predetermined profile corresponding to a background or a predetermined substance included in the measured profile, or a restriction of a coefficient matrix of the predetermined profile; and
applying non-negative matrix factorization to the measured profile based on the known information.

10. A non-transitory computer readable recording medium having recorded thereon a program for applying non-negative matrix factorization to one or more measured profiles of X-ray powder diffraction, the program causing a computer to execute the processes of:
acquiring one or more measured profiles;
acquiring known information including a shape of a predetermined profile corresponding to a background or a predetermined substance included in the measured profile, or a restriction of a coefficient matrix of the predetermined profile; and
applying non-negative matrix factorization to the measured profile based on the known information.
